(19) United States
(12) Patent Application Publication
(10) Pub. No.: US 2018/0336578 A1
(43) Pub. Date: Nov. 22, 2018

(54) INTEREST LEVEL EVALUATION METHOD, INTEREST LEVEL EVALUATING DEVICE AND RECORDING MEDIUM

(71) Applicant: FUJITSU LIMITED, Kawasaki-shi (JP)

(72) Inventors: Teruyuki SATO, Tama (JP); Koichiro NIINUMA, Kawasaki (JP)

(73) Assignee: FUJITSU LIMITED, Kawasaki-Shi (JP)

(21) Appl. No.: 15/978,566

(22) Filed: May 14, 2018

(30) Foreign Application Priority Data
May 16, 2017 (JP) 2017-097641

(51) Int. Cl. G06Q 30/02

(52) U.S. Cl. CPC G06Q 30/0201

(57) ABSTRACT

An interest level evaluation method executed by a processor of a computer, the interest level evaluation method includes detecting an operational state within a time period during which an information processing terminal displays a content; calculating, for each of parameter values related to the operational state, a level of interest in the content for each of unit time periods based on the detected operational state and the parameter values; calculating, for each of the parameter values, amounts of change in the level of interest during a plurality of time intervals arranged in chronological order based on the level of interest calculated for each of the unit time periods; and evaluating the level of interest in the content by comparing the calculated amounts of change in the interest levels for each of the parameter values with the calculated amounts of change in the level of interest for another parameter value.

### CROSS-REFERENCE TO RELATED APPLICATION

This application is based upon and claims the benefit of priority of the prior Japanese Patent Application No. 2017-97641, filed on May 16, 2017, the entire contents of which are incorporated herein by reference.

### FIELD

The embodiments discussed herein are related to an interest level evaluation method, an interest level evaluating device and a recording medium.

### BACKGROUND

There is a method for analyzing “where” in a web page that a large number of unspecified users who browse the web page are interested. “Where” in a web page that users access does the users have interest and “where” in the web page is the cause for the users to leave the web page are valuable as customer information.

The inbound marketing method for increasing potential purchase intention of persons who visit web pages and causing actual purchase behaviors is known. In the inbound marketing method, an access analysis technique for measuring interest levels indicating the degrees of interest in contents from users' behaviors on web pages is used. By taking advantaging of the interest levels, persons who have created the web pages may confirm whether the web pages attract interest as expected and may improve the web pages so that the web pages attract more interest. By taking advantaging of the interest levels, it is possible to promote users who have visited the web pages to receive a service of estimating targets in which the users are interested and recommending documents. Recently, the number of times of access to web pages from smartphones is increasing. If customer information is acquired from users who use smartphones, the number of contents valuable for the users may be increased.

In the aforementioned technique, browsing time periods are basically measured, and interest levels are measured based on the lengths of the measured browsing time periods. For example, a technique for calculating a browsing time periods (normalized browsing time periods) per unit amount of information of a document within a content and estimating an interest score as an interest level based on the time period for browsing the document within a time interval is known.

Especially, a technique for detecting a certain region within a content, which is fixedly laid out and is electronic newspaper or an electronic magazine, and detecting, based on an enlargement operation, a region that is within the content and in which a user is interested is known. As related art, Japanese Laid-open Patent Publication No. 2012-238114, Japanese Laid-open Patent Publication No. 2010-237942, and the like have been disclosed, for example.

In the aforementioned technique for estimating interest levels, levels of interest in segment units of prescribed contents during time intervals may be detected. The interest levels detected in the aforementioned technique depend on the contents, and a database to be used to detect the interest levels or the like is to be created based on details of the contents. Even a method for detecting, based on an enlargement operation, a region that is included in a content and in which a user is interested has a problem with layout dependency. Especially, in a smartphone, the layout may be automatically changed due to the limitation of the horizontal width of the smartphone, and the limitation of the horizontal width varies depending on the resolution of the device. Thus, an enlargement operation varies depending on the type of the device, and it is difficult to uniformly detect interest levels.

As described above, the conventional method for measuring interest levels depend on contents, and if the contents are variously recreated, the resolutions of portions that attract interest are increased, and levels of interest in the contents are evaluated, it takes so much time to evaluate the interest levels. Under such circumstances, it is preferable to reduce a load to be applied to a process of evaluating levels of users' interest in contents.

### SUMMARY

According to an aspect of the invention, an interest level evaluation method executed by a processor of a computer, the interest level evaluation method includes detecting an operational state within a time period during which an information processing terminal displays a content; calculating, for each of a plurality of parameter values related to the operational state, a level of interest in the content for each of a plurality of unit time periods based on the detected operational state and the plurality of parameter values; calculating, for each of the plurality of parameter values, amounts of change in the level of interest during a plurality of time intervals arranged in chronological order based on the level of interest calculated for each of the plurality of unit time periods; and evaluating the level of interest in the content by comparing the calculated amounts of change in the interest levels for each of the plurality of parameter values with the calculated amounts of change in the level of interest for another parameter value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating a configuration of an interest level evaluation system according to a first embodiment;

FIG. 2 is a diagram illustrating an example of a method for setting a weight coefficient for a scrolling velocity;

FIG. 3 is a diagram illustrating an example of the case where an integrated value of the amount of change in a calculated interest level is expressed as a graph;

FIG. 4 is a diagram illustrating an example of graphs indicating amounts of change in interest levels as integrated values in the case where the amounts of change in the interested levels are calculated for parameters indicating scrolling velocities;

FIG. 5 is a diagram illustrating an example of time intervals over a threshold and identified parameter values stored in a user information storage section according to the first embodiment;

FIG. 6 is a block diagram schematically illustrating a configuration of a computer that functions as an information processing terminal according to the first embodiment;

FIG. 7 is a block diagram schematically illustrating a configuration of a computer that functions as a content server according to the first embodiment;

FIG. 8 is a flowchart illustrating an example of an interest level evaluation process according to the first embodiment;

FIG. 9 is a block diagram schematically illustrating a configuration of an interest level evaluation system according to a second embodiment;

FIG. 10 is a diagram illustrating an example of a method for setting weight coefficients for a terminal momentum;

FIG. 11 is a diagram illustrating an example of time intervals over a threshold and identified parameter values stored in a user information storage section according to the second embodiment;

FIG. 12 is a block diagram schematically illustrating a configuration of a computer that functions as an information processing terminal according to the second embodiment;

FIG. 13 is a block diagram schematically illustrating a configuration of a computer that functions as a user information managing server according to the second embodiment;

FIG. 14 is a flowchart illustrating an example of an interest level evaluation process according to the second embodiment;

FIG. 15 is a block diagram schematically illustrating a configuration of an interest level evaluation system according to a third embodiment;

FIG. 16 is a diagram illustrating an example of a method for setting weight coefficients for a screen enlargement rate;

FIG. 17 is a block diagram schematically illustrating a configuration of a computer that functions as an information processing terminal according to the third embodiment;

FIG. 18 is a block diagram schematically illustrating a configuration of a computer that functions as a user information managing server according to the third embodiment; and

FIG. 19 is a flowchart illustrating an example of an interest level evaluation process according to the third embodiment.

### DESCRIPTION OF EMBODIMENTS

Hereinafter, an example of embodiments is described in detail with reference to the accompanying drawings.

Traditionally, to evaluate an interest level indicating the degree of user's interest in a content, an interest level is evaluated for each segment of the content. Thus, if the content is recreated, it takes time and effort and is costly. In the conventional technique, the evaluation of interest levels depends on contents.

To solve the aforementioned problems, the following two principles are introduced and interest levels are evaluated using a method that does not depend on contents. The following two principles are based on the assumption that a state in which a user becomes “interested in a content” is a psychographic change, and the psychographic change appears as a variation in a reading manner.

As the first principle, an interest level obtained by quantifying an operational state of an information processing terminal of a user is introduced as a level that changes as time passes. By using time-series data of operational states of the information processing terminal instead of using segments of contents, interest levels may be evaluated without dependency on contents. For example, a portion that is included in a content and attracts user's interest and a portion that is included in the content and does not attract user's interest are detected based on operational states such as input operations (mouse scrolling, tapping, and the like) of continuously reading a web page or the momentum of the terminal. The portion that attracts user's interest may be used for digital marketing as customer information fed back from the user for the content of the web page.

As the second principle, characteristic patterns that appear in time-series data of interest levels are paid attention. This is due to the fact that when a user becomes interested in a content, a characteristic pattern that is not monotonous appears in time-series data after a monotonous pattern by a monotonous page-scrolling operation. The characteristic pattern is obtained from the collection and analysis of actual data. Thus, by detecting the characteristic pattern in the time-series data, it is possible to detect a content portion attracting user's interest and identify characteristics of the user.

The embodiments are based on the aforementioned two principles and described below.

### First Embodiment

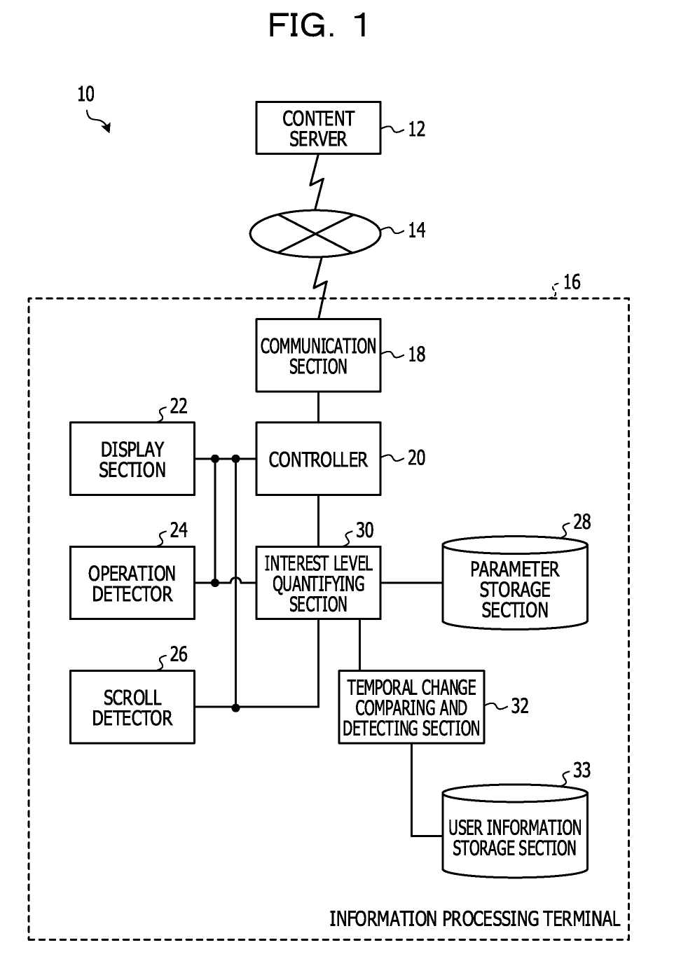

An interest level evaluation system 10 illustrated in FIG. 1 includes a content server 12 and an information processing terminal 16. The content server 12 and the information processing terminal 16 are connected to each other via a network 14 such as the Internet, for example.

The content server 12 transmits a content to the information processing terminal 16 in response to a content request signal from the information processing terminal 16.

The information processing terminal 16 includes a communication section 18, a controller 20, a display section 22, an operation detector 24, a scroll detector 26, a parameter storage section 28, an interest level quantifying section 30, a temporal change comparing and detecting section 32, and a user information storage section 33. The information processing terminal 16 is an example of an interest level evaluating device. The interest level quantifying section 30 and the temporal change comparing and detecting section 32 are an example of an interest level evaluator.

The communication section 18 transmits and receives information to and from the content server 12. For example, the communication section 18 receives the content transmitted by the content server 12. The communication section 18 transmits, to the content server 12, the content request signal output by the controller 20 described later. The communication section 18 may periodically transmit information stored in the user information storage section 33 to an external server for user management.

The controller 20 controls the display section 22 (described later) to cause the display section 22 to display the content received by the communication section 18. The controller 20 controls the display section 22 based on user operation information (described later) detected by the operation detector 24 and a scrolling amount (described later) detected by the scroll detector 26 so that a content desired by a user is displayed.

The display section 22 is achieved by a liquid crystal display (LCD), an organic electroluminescence display (OELD), or the like, for example. The display section 22 displays the content based on control by the controller 20. It is sufficient if the content provided by the content server 12 is able to be displayed by the display section 22. The content provided by the content server 12 may include a content including a text such as a document or a content including an image.

The operation detector 24 receives an input operation by the user from a touch panel superimposed on the display section 22 and detects the input operation by the user within a time period during which the information processing terminal 16 displays the content. Specifically, the operation detector 24 detects the type of the input operation by the user, such as a tap operation, a flip operation, a swipe operation, a pinch operation, or the like. The operation detector 24 detects the time when the input operation is performed and coordinates of a position at which a user's finger contacts the touch panel. The operation detector 24 detects a scroll operation of scrolling a screen from the type of the input operation. Then, the operation detector 24 measures an operation time period within each of unit time periods. Each operation time period includes a scroll operation time period during which a scroll operation is performed. The operation detector 24 measures a no-operation time period that is included in each of the unit time periods and during which any operation is not performed. Thus, the operation detector 24 detects operation information including the type of an input operation, the time when the input operation is performed, a contact position, an operation time period within each of the unit time periods, and a no-operation time period, which are an example of operational states of the information processing terminal 16.

The scroll detector 26 calculates a scrolling velocity that is an example of an operational state of the information processing terminal 16 during a time period for a scroll operation detected by the operation detector 24. The scrolling velocity indicates the velocity of scrolling on the screen on which the content is displayed. Specifically, the scroll detector 26 detects the amount (pixels) of the scrolling input by the user on the screen from the touch panel superimposed on the display section 22. Then, the scroll detector 26 divides the amount of the scrolling by the time period (seconds) for the scroll operation detected by the operation detector 24 and calculates the scrolling velocity (pixels per second (pixels/s)) per unit time period.

In the parameter storage section 28, multiple parameter values to be used to determine a threshold to be used for the interest level quantifying section 30 (described later) to calculate interest levels are stored. If the stored parameter values indicate scrolling velocities, the multiple parameter values are 70 (pixels/s), 150 (pixels/s), 500 (pixels/s), and the like.

The interest level quantifying section 30 calculates interest levels during each of the unit time periods based on a time period for a scroll operation detected by the operation detector 24, a no-operation time period, and a scrolling velocity calculated by the scroll detector 26. The interest level quantifying section 30 calculates the interest levels for each of the parameter values stored in the parameter storage section 28 and indicating scrolling velocities. The following exemplifies the case where 70 (pixels/s) and 500 (pixels/s) are used as parameter values, and interest levels are calculated using the parameter values.

For example, the interest level quantifying section 30 determines a weight coefficient for a scrolling velocity detected by the scroll detector 26, based on the threshold determined based on a parameter value stored in the parameter storage section 28 and indicating a scrolling velocity. A method for determining the scrolling velocity weight coefficient is described later. Then, the interest level quantifying section 30 calculates a level I(t) of user's interest in the content according to the following Equation (1) based on a scroll operation time period, a no-operation time period, and the scrolling velocity weight coefficient. The scrolling velocity weight coefficient is an example of a change in a scrolling velocity from a calculated velocity of a first scroll operation to a calculated velocity of a second scroll operation.

$$I ( t ) = \sum \frac{A time period for a scroll operation}{The scrolling velocity weight coefficient {w}_{scr}} + \sum A no \text{-} operation time period \qquad Equation ( 1 )$$

In the first embodiment, the level I(t) of interest in the content is calculated for each unit time period (of 1 second as an example). In the aforementioned Equation (1), the “scroll operation time period” indicates a time period for a scroll operation within a unit time period, and the “no-operation time period” indicates a no-operation time period within the unit time period. The interest level I(t) is calculated in the form of an integrated value during each of the unit time periods from the time when the display of the content is started to time t.

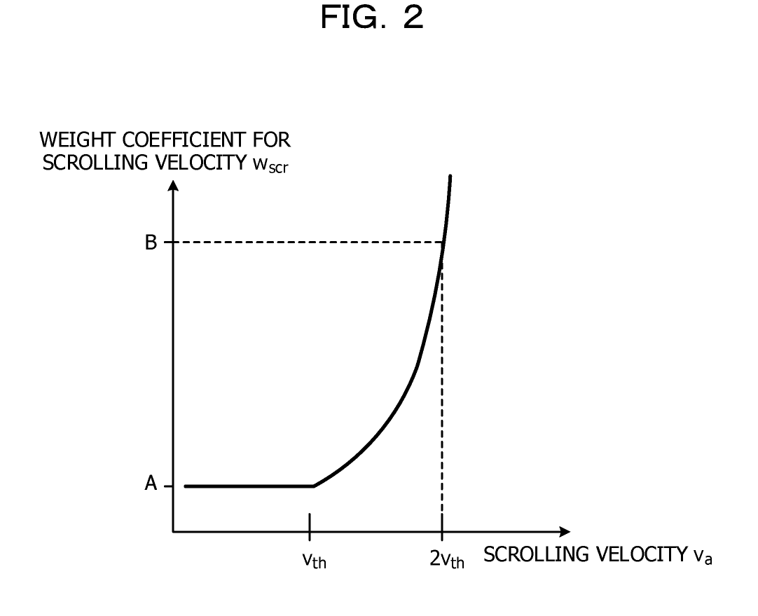

FIG. 2 illustrates an example of a method for setting the scrolling velocity weight coefficient w_{scr} for each of the unit time periods. The scrolling velocity weight coefficient w_{scr} is included in the aforementioned Equation (1). As illustrated in FIG. 2, the velocity weight coefficient w_{scr} is set so that the scrolling velocity weight coefficient w_{scr} is fixed value if a scrolling velocity vₐ is in a range of 0 to a threshold vₜₕ. The scrolling velocity weight coefficient w_{scr} may be set in advance so that if the scrolling velocity vₐ is equal to or larger than the threshold vₜₕ, the scrolling velocity weight coefficient w_{scr} increases with an increase in the scrolling velocity vₐ. For example, as illustrated in FIG. 2, the scrolling velocity weight coefficient w_{scr} is set so that when the scrolling velocity vₐ increases from vₜₕ to 2vₜₕ, the weight coefficient w_{scr} for the scrolling velocity vₐ increases from A to B. Specifically, in the aforementioned Equation (1), as the scrolling velocity is higher, the scrolling velocity weight coefficient w_{scr} is larger. As a result, the interest level during the scroll operation is evaluated to be low. Similarly, as a time period during the stop of the scroll operation is shorter, the interest level is evaluated to be lower. Specifically, if the reading of the content is skipped, the interest level is evaluated to be low in Equation (1). On the other hand, if the scroll operation is performed at a low speed so that eyeballs are able to be traced or the user reads the content while stopping the scroll operation, the interest level is evaluated to be high in Equation (1). For example, if a scrolling velocity of 70 (pixels/s) is used as a parameter value, the interest level is calculated in a state in which the scrolling velocity of 70 (pixels/s) is used as the threshold vₜₕ and in which if the scrolling velocity is equal to or higher than 70 (pixels/s), the scrolling velocity weight coefficient is increased with an increase in the scrolling velocity. If a scrolling velocity of 500 (pixels/s) is used as the parameter value, the interest level is calculated in a state in which the scrolling velocity of 500 (pixels/s) is used as the threshold vₜₕ and in which if the scrolling velocity is equal to or higher than 500 (pixels/s), the scrolling velocity weight coefficient is increased with an increase in the scrolling velocity.

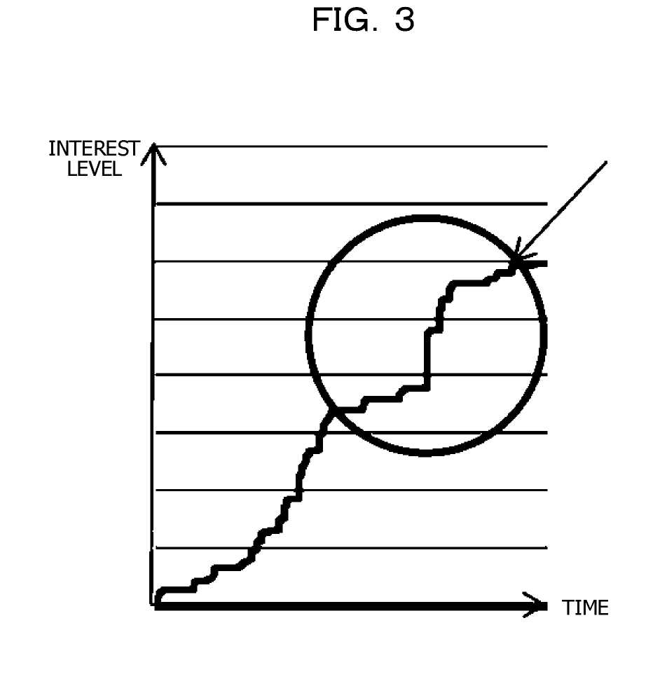

The interest level quantifying section 30 calculates, as the amount of change in an interest level during each of time intervals arranged in chronological order, the difference between an interest level calculated during a unit time period including a previous time point and an interest level calculated during a unit time period including the current time point. FIG. 3 illustrates an example of the case where a change in an interest level over time is calculated in the form of an integrated value and expressed as a graph. In the graph illustrated in FIG. 3, an inclination during a time interval from a certain unit time period to the next unit time period indicates the amount of change in the interest level. In the graph illustrated in FIG. 3, it may be said that a time interval during which the interest level rapidly increases exists and a characteristic pattern of the amount of change in the interest level appears during the time interval. A scrolling velocity detected during the unit time period including the previous time point is an example of the velocity of the first scroll operation. A scrolling velocity detected during the unit time period including the current time point is an example of the velocity of the second scroll operation.

The temporal change comparing and detecting section 32 compares change amounts calculated for each of all the parameter values during each of the time intervals arranged in chronological order with change amounts calculated for the other parameter values during each of the time intervals. The temporal change comparing and detecting section 32 detects the same time interval during which change amounts calculated for two or more parameter values are equal to or larger than a predetermined threshold. The temporal change comparing and detecting section 32 compares change amounts during a time interval preceding the detected same time interval during which the change amounts are equal to or larger than the predetermined threshold. Then, the temporal change comparing and detecting section 32 identifies a parameter value for which a change amount that is larger than a change amount calculated for the other parameter value during the preceding time interval has been calculated. Then, the temporal change comparing and detecting section 32 causes the detected same time interval (time interval over the threshold) and the identified parameter value to be stored in the user information storage section 33. In this case, the time interval over the threshold and the identified parameter value are associated with a user ID, a content ID, and access time and stored in the user information storage section 33. The access time may be a time point when an operation performed on the content has been initially detected. The temporal change comparing and detecting section 32 causes the position, associated with time-series data, of the content on the display screen to be stored in the user information storage section 33. The temporal change comparing and detecting section 32 may compare not only the change amounts during the preceding time interval but also change amounts during a time interval succeeding the detected same time interval and identify parameter values. The temporal change comparing and detecting section 32 detects the same time interval during which the change amounts calculated for the two or more parameter values are equal to or larger than the predetermined threshold. The temporal change comparing and detecting section 32, however, may detect the same time interval during which change amounts calculated for three or more parameter values are equal to or larger than the predetermined threshold, depending on the number of the parameter values.

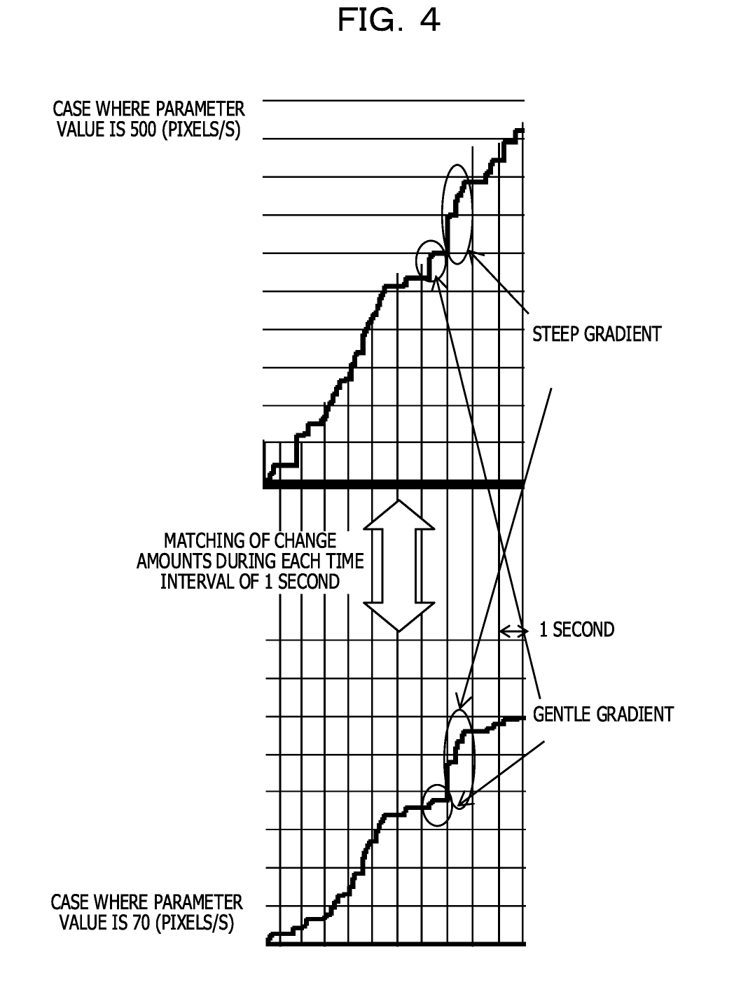

FIG. 4 illustrates an example of a graph indicating changes in interest levels over time in the case where the amounts of change in the interest levels over time are calculated for parameter values indicating the scrolling velocities of 70 (pixels/s) and 500 (pixels/s). As illustrated in FIG. 4, the temporal change comparing and detecting section 32 compares the change amounts for the pair of parameter values of 70 (pixels/s) and 500 (pixels/s) during the time intervals. The temporal change comparing and detecting section 32 detects, as a result of the comparison, the same time interval during which change amounts per unit time period are large or gradients of the change amounts are steep for the parameter values or the time interval (time interval during which the interest levels are high) during which the interest levels rapidly increase in the graph or the amounts of change in the interest levels are large. Then, the temporal change comparing and detecting section 32 also compares change amounts during a time interval preceding the time interval during which the gradients are steep. During the time interval preceding the time interval during which the gradients are steep, gradients are gentler than those during the time interval during which the change amounts are equal to or larger than the threshold. The temporal change comparing and detecting section 32 identifies a parameter value for which a change amount that is larger than a change amount calculated for the other parameter value during the preceding time interval has been calculated. During a time interval during which a steep gradient that indicates a high interest level appears, a characteristic change in a change amount due to a change in a parameter value does not exist. However, during a time interval during which the interest level is low and that precedes a time period during which a steep gradient appears, changes in the interest levels are different for the parameter values. In the example illustrated in FIG. 4, during the time interval preceding the time interval during which the gradients are steep, the amount of change for the parameter value of 500 (pixels/s) is larger than the amount of change for the parameter value of 70 (pixels/s). It is apparent that a characteristic pattern of change amounts for the parameter value of 500 (pixels/s) appears, while the characteristic pattern does not appear for the parameter value of 70 (pixels/s). Specifically, parameter values specific to the user are clarified by comparing change amounts calculated for multiple parameter values. Based on the identified parameter value, it is possible to capture psychographic characteristics specific to the user or characteristics (whether the scrolling velocity is high or low and the like) of operations by the user.

The first embodiment exemplifies the case where the number of parameter values is 2 for convenience of description. Interest levels and amounts of change in the interest levels may be calculated for three or more parameter values, and the calculated amounts of change in the interest levels may be compared.

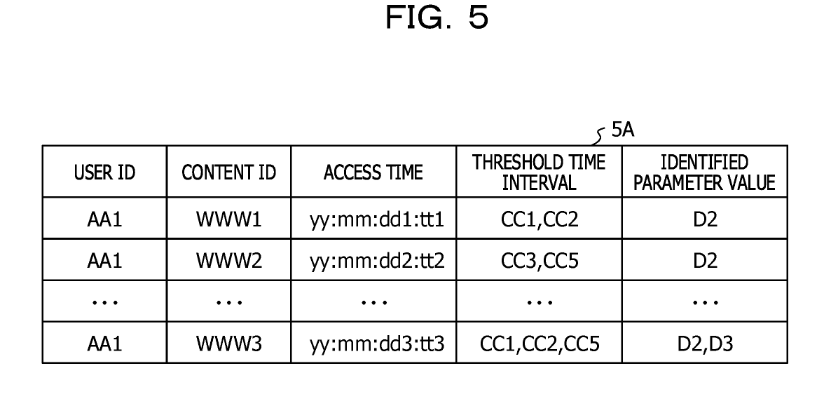

In the user information storage section 33, time intervals over the threshold and identified parameter values are associated with user IDs, content IDs, and access time and stored as user-specific information. For example, a table 5A illustrated in FIG. 5 indicates that a user who has a user ID “AA1” browses a content having a content ID “WWW1” at time “yy:mm:dd1:tt1” and that time intervals over the threshold detected by the temporal change comparing and detecting section 32 upon the browsing are “CC1 and CC2” and a parameter value identified by the temporal change comparing and detecting section 32 upon the browsing is “D2”. In the user information storage section 33, the positions, associated with the time-series data, of contents on the display screen are stored.

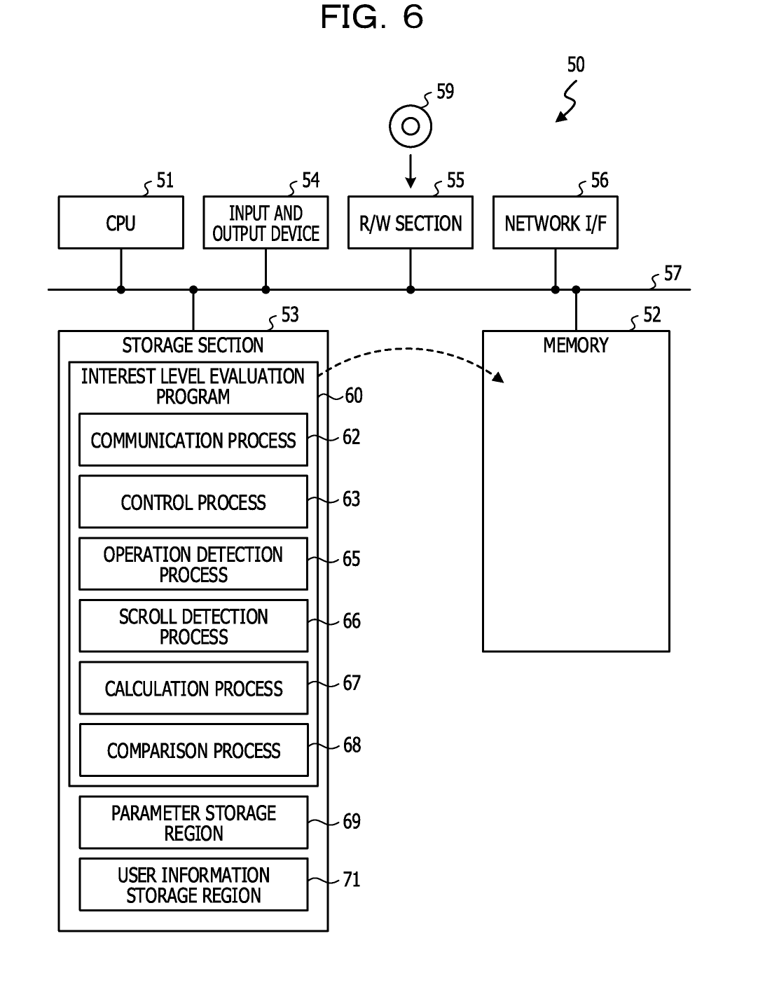

The information processing terminal 16 may be achieved by a computer 50 illustrated in FIG. 6, for example. The computer 50 includes a CPU 51, a memory 52 as a temporal storage region, and a nonvolatile storage section 53. The computer 50 further includes an input and output device 54 including the display section 22 and the touch panel superimposed on the display section 22, and a reading and writing (R/W) section 55 that controls reading and writing of data from and to a recording medium 59. The computer 50 further includes a network interface (I/F) 56 that is connected to the network such as the Internet. The CPU 51, the memory 52, the storage section 53, the input and output device 54, the R/W section 55, and the network I/F 56 are connected to each other via a bus 57.

The storage section 53 may be achieved by a hard disk drive (HDD), a solid state drive (SSD), a flash memory, or the like. In the storage section 53 serving as a storage medium, an interest level evaluation program 60 that causes the computer 50 to function as the information processing terminal 16 is stored. The interest level evaluation program 60 includes a communication process 62, a control process 63, an operation detection process 65, a scroll detection process 66, a calculation process 67, and a comparison process 68. The storage section 53 includes a parameter storage region 69 in which information constituting the parameter storage section 28 is stored. The storage section 53 includes a user information storage region 71 in which information constituting the user information storage section 33 is stored.

The CPU 51 reads the interest level evaluation program 60 from the storage section 53, loads the read interest level evaluation program 60 into the memory 52, and sequentially executes the processes included in the interest level evaluation program 60. The CPU 51 executes the communication process 62, thereby operating as the communication section 18 illustrated in FIG. 1. The CPU 51 executes the control process 63, thereby operating as the controller 20 illustrated in FIG. 1. The CPU 51 executes the operation detection process 65, thereby operating as the operation detector 24 illustrated in FIG. 1. The CPU 51 executes the scroll detection process 66, thereby operating as the scroll detector 26 illustrated in FIG. 1. The CPU 51 executes the calculation process 67, thereby operating as the interest level quantifying section 30 illustrated in FIG. 1. The CPU 51 executes the comparison process 68, thereby operating as the temporal change comparing and detecting section 32 illustrated in FIG. 1. The CPU 51 reads the information from the parameter storage region 69 and loads the parameter storage section 28 into the memory 52. Thus, the CPU 51 executes the interest level evaluation program 60, thereby functioning as the information processing terminal 16. The CPU 51 that executes the program is hardware.

The functions that are achieved by the interest level evaluation program 60 may be achieved by a semiconductor integrated circuit, or more specifically, by an application specific integrated circuit (ASIC) or the like, for example.

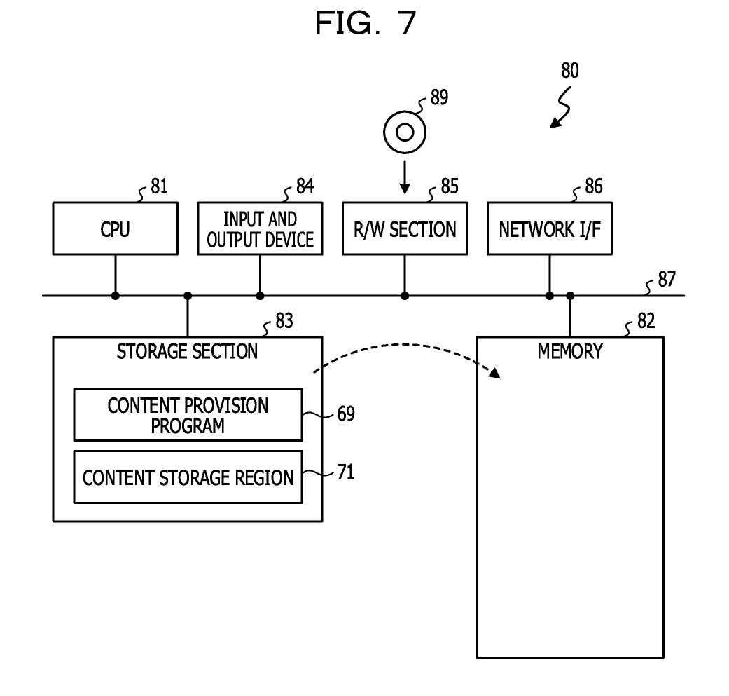

The content server 12 may be achieved by a computer 80 illustrated in FIG. 7, for example. The computer 80 includes a CPU 81, a memory 82 as a temporal storage region, and a nonvolatile storage section 83. The computer 80 further includes an input and output device 84 including a display device, an input device, and the like, and an R/W section 85 that controls reading and writing of data from and to a recording medium 89. The computer 80 further includes a network I/F 86 that is connected to the network such as the Internet. The CPU 81, the memory 82, the storage section 83, the input and output device 84, the R/W section 85, and the network I/F 86 are connected to each other via a bus 87.

The storage section 83 may be achieved by an HDD, an SSD, a flash memory, or the like. In the storage section 83 serving as a storage medium, a content provision program 90 that causes the computer 80 to function as the content server 12 is stored. In a content storage region 98, contents able to be provided to the information processing terminal 16 are stored in advance.

The function that is achieved by the content provision program 90 may be achieved by a semiconductor integrated circuit, or more specifically, by an ASIC or the like, for example.

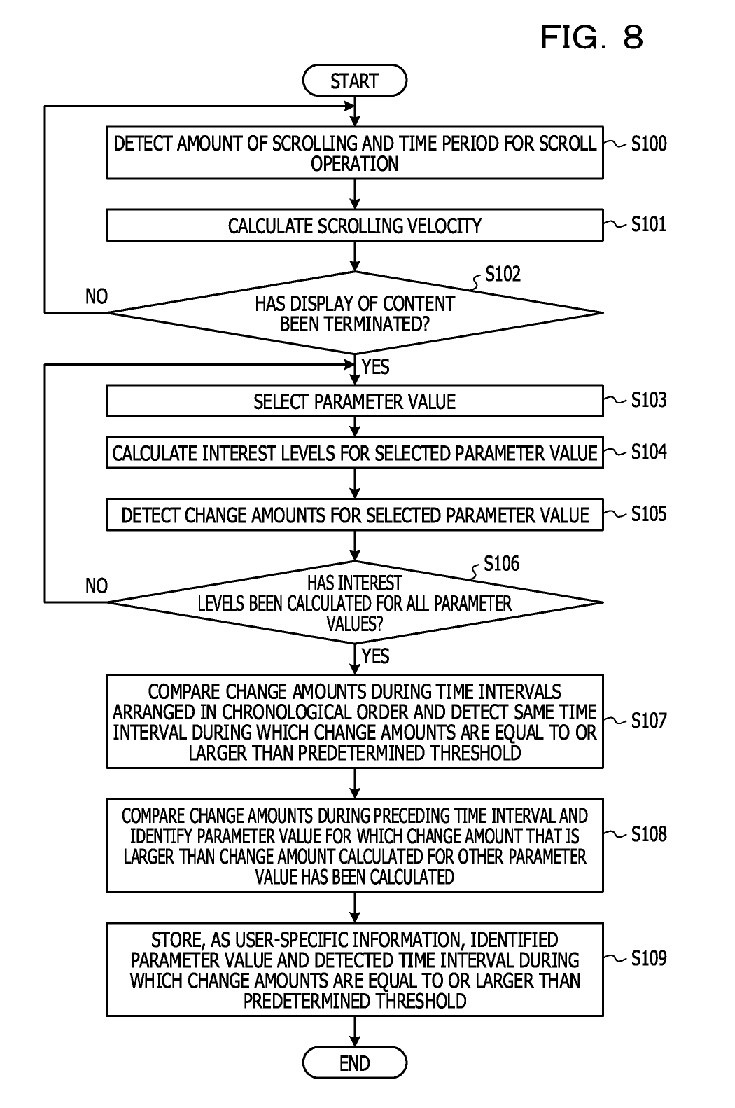

Next, effects of the interest level evaluation system 10 according to the first embodiment are described. In the interest level evaluation system 10, the information processing terminal 16 receives a content from the content server 12. Then, the received content is displayed by the display section 22 of the information processing terminal 16. When the operation detector 24 receives an input operation by a user, an interest level evaluation process illustrated in FIG. 8 is executed by the information processing terminal 16. Processes are described below.

In S100, the operation detector 24 detects a time period for a scroll operation by the user within a unit time period. The scroll detector 26 detects the amount of the scrolling input by the user on the screen from the touch panel superimposed on the display section 22.

In S101, the scroll detector 26 divides the detected amount of the scrolling by the scroll operation time period detected in the aforementioned S100 within the unit time period and calculates the scrolling velocity (pixels/s).

In S102, the interest level quantifying section 30 determines whether or not the display of the content has been terminated. If the display has been terminated, the process proceeds to S103. If the display has not been terminated, the process returns to S100 and is repeated.

In S103, the interest level quantifying section 30 selects a parameter value stored in the parameter storage section 28 and indicating a scrolling velocity.

In S104, the interest level quantifying section 30 calculates, for the parameter value selected in S103, an interest level during each of unit time periods. The interest level during each of the unit time periods is calculated according to the aforementioned Equation (1) based on the scroll operation time period detected in S100, a no-operation time period, and the scrolling velocity calculated in S101.

In S105, the interest level quantifying section 30 calculates, for the parameter value selected in S103, amounts of change in the interest levels during the unit time periods. Each of the change amounts is calculated as the difference between an interest level calculated during a unit time period that is included in the time intervals arranged in chronological order and includes a previous time point and an interest level calculated during a unit time period that is included in the time intervals arranged in chronological order and includes the current time point.

In S106, it is determined whether interest levels and amounts of change in the interest levels have been calculated for the all parameter values stored in the parameter storage section 28. If the interest levels and the amounts of change in the interest levels have been calculated for all the parameter values as a result of the determination, the process proceeds to S107. On the other hand, if interest levels and the amounts of change in the interest levels have not been calculated for one or more of all the parameter values, the process returns to S103, the next parameter value is selected, and the process is repeated.

In S107, the temporal change comparing and detecting section 32 compares the change amounts calculated for each of the parameter values during the time intervals arranged in chronological order with the change amounts calculated for the other parameter values during the time intervals arranged in chronological order. Then, the temporal change comparing and detecting section 32 detects the same time interval during which change amounts calculated for two or more parameter values are equal to or larger than the predetermined threshold.

In S108, the temporal change comparing and detecting section 32 compares change amounts during a time interval preceding the detected same time interval during which the change amounts are equal to or larger than the predetermined threshold, and identifies a parameter value for which a change amount that is larger than a change amount calculated for the other parameter value during the preceding time interval has been calculated.

In S109, the temporal change comparing and detecting section 32 causes the same time interval detected in S107 and the parameter value identified in S108 to be stored in the user information storage section 33. In this case, the information is stored while being associated with information (user ID, content ID, and access time) specific to the user who has browsed the content.

As described above, upon receiving an input operation within a time period during which the information processing terminal displays a content, the interest level evaluation system according to the first embodiment detects operational states including the velocity of a scroll operation. Then, the information processing terminal calculates interest levels for the parameter values based on the detected operational states and calculates amounts of change in the interest levels during the time intervals arranged in chronological order. Then, the information processing terminal compares the amounts of change in the interest levels and detects the same time interval during which change amounts calculated for two or more parameter values are equal to or larger than the predetermined threshold. Then, the information processing terminal compares change amounts during a time interval preceding the detected same time interval and identifies a parameter value for which a change amount that is larger than a change amount calculated for the other parameter value during the preceding time interval has been calculated. Consequently, evaluation precision of the levels of users' interest in contents may be improved without depending on the contents.

### Second Embodiment

Next, a second embodiment is described. Sections that are the same as those described in the first embodiment are indicated by the same reference symbols as those described in the first embodiment, and a description thereof is omitted.

The second embodiment is different from the first embodiment in that the momentum of an information processing terminal is used for interest level evaluation in the second embodiment. The second embodiment is different from the first embodiment in that the interest level evaluation is executed by a user information managing server in the second embodiment. The momentum of the terminal is an example of a “motion”.

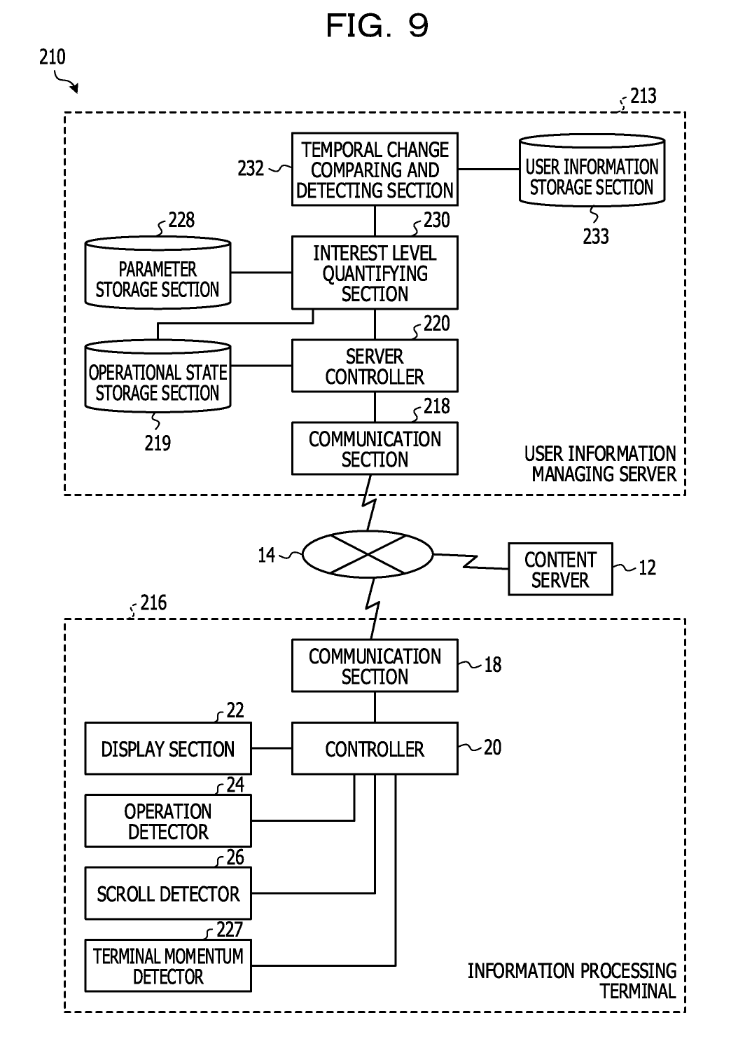

An interest level evaluation system 210 illustrated in FIG. 9 according to the second embodiment includes the content server 12, an information processing terminal 216, and a user information managing server 213. The content server 12, the information processing terminal 216, and the user information managing server 213 are connected to each other via the network 14 such as the Internet.

The information processing terminal 216 includes the communication section 18, the controller 20, the display section 22, the operation detector 24, the scroll detector 26, and a terminal momentum detector 227.

The terminal momentum detector 227 detects the momentum of the information processing terminal 216 for each of the unit time periods. The terminal momentum is an example of an operational state of the information processing terminal 216. The second embodiment describes the case where the terminal momentum detector 227 is achieved by a 9-axis sensor. The 9-axis sensor is composed of three types of sensors, a triaxial gyro sensor, a triaxial acceleration sensor, and a triaxial geomagnetic sensor. The terminal momentum detector 227 may be achieved by one or more of the three types of sensors. In this case, the unit time periods are predetermined detection cycles T (of 1 second as an example).

The communication section 18 according to the second embodiment transmits, to the user information managing server 213 based on a control process by the controller 20, operation information including the type of an input operation detected by the operation detector 24, the time when the input operation has been performed, a contact position, a time period for the operation, and a no-operation time period. In the second embodiment, the operation information also includes a scrolling velocity detected by the scroll detector 26. The communication section 18 transmits, to the user information managing server 213, the terminal momentum detected by the terminal momentum detector 227. The operation information to be transmitted and the terminal momentum to be transmitted are associated with a user ID, a content ID of a content being displayed, and detection time for each of the unit time periods. The communication section 18 also transmits the position, associated with time-series data, of the content on the display screen.

The user information managing server 213 includes a communication section 218, an operational state storage section 219, a server controller 220, a parameter storage section 228, an interest level quantifying section 230, a temporal change comparing and detecting section 232, and a user information storage section 233.

The communication section 218 transmits and receives information to and from the information processing terminal 216. For example, the communication section 218 receives, from the information processing terminal 216, the operation information and terminal momentum associated with the user ID, the content ID, and the detection time. The communication section 218 receives the position, associated with the time-series data, of the content on the display screen.

The server controller 220 acquires the operation information and terminal momentum received by the communication section 218 and causes the acquired operation information and the acquired terminal momentum to be stored in the operational state storage section 219. The server controller 220 notifies the interest level quantifying section 230 that the newly received operation information and the newly received terminal momentum have been stored in the operational state storage section 219. The server controller 220 causes the position, associated with the time-series data, of the content on the display screen to be stored in the user information storage section 233.

In the operational state storage section 219, terminal momentums and operation information that are associated with user IDs, content IDs, and detection time are stored.

In the parameter storage section 228, multiple parameter values to be used to determine thresholds to be used for the interest level quantifying section 230 (described later) to quantify a change in the terminal momentum are stored. If the stored parameter values indicate scrolling velocities, the multiple parameter values are, for example, 70 (pixels/s), 150 (pixels/s), 500 (pixels/s), and the like. If the multiple parameter values indicate terminal momentums, the multiple parameter values are, for example, 0.05 (rad/s²), 0.01 (rad/s²), 0.0025 (rad/s²), and the like. Each of the values of the terminal momentums stored as the parameter values is obtained by acquiring and measuring a rotational momentum of the information processing terminal five times per second and calculating the sum of squares of the rotational momentums.

The interest level quantifying section 230 calculates interest levels for each of the unit time periods based on the operation time periods, no-operation time periods, and terminal momentums included in the operation information stored in the operational state storage section 219. The interest level quantifying section 230 calculates the aforementioned interest levels for the multiple parameter values stored in the parameter storage section 228 and indicating the terminal momentums. The interest level quantifying section 230 may calculate interest levels for the multiple parameter values indicating the scrolling velocities in the same manner as the aforementioned first embodiment and calculate interest levels for the multiple parameter values indicating the terminal momentums.

For example, the interest level quantifying section 230 determines weight coefficients for the terminal momentum based on the thresholds determined based on the parameter values stored in the parameter storage section 228 and indicating the terminal momentums. Then, the interest level quantifying section 230 calculates a level I(t) of user's interest in the content according to the following Equation (2) based on an operation time period, a no-operation time period, and the weight coefficients for the terminal momentum. The weight coefficients for the terminal momentum are an example of a change in the terminal momentum.

$$I ( t ) = \sum \frac{An operation time period}{The terminal momentum weight coefficient {w}_{d}} + \sum \frac{A no \text{-} operation time period}{The terminal momentum weight coefficient {w}_{nop}} \qquad Equation ( 2 )$$

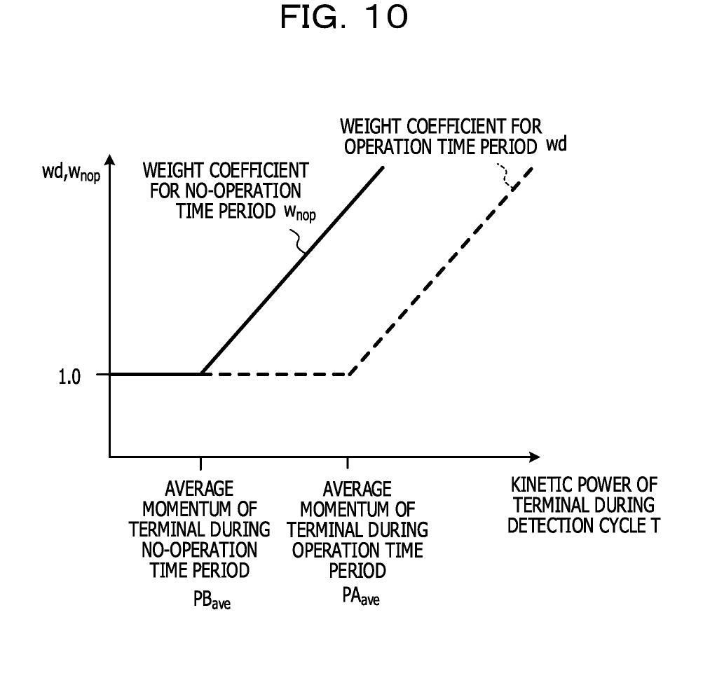

In the second embodiment, the level I(t) of interest in the content is calculated for each of the unit time periods (of 1 second as an example). In the aforementioned Equation (2), the “operation time period” is a time period for an operation within a unit time period, and a “no-operation time period” is a time period that is included in the unit time period and during which any operation is not performed. The weight coefficients for the terminal momentum are set as a terminal momentum weight coefficient w_{d} for the operation time period and a terminal momentum weight coefficient wₙₒₚ for the no-operation time period. For example, as illustrated in FIG. 10, the terminal momentum weight coefficient w_{d} for the operation time period is calculated from the kinetic power of the information processing terminal during the operation time period included in the unit time period and a threshold PAₐᵥₑ for the momentum during the operation time period. As illustrated in FIG. 10, the terminal momentum weight coefficient wₙₒₚ for the no-operation time period is calculated from the kinetic power of the information processing terminal during the no-operation time period included in the unit time period and a threshold PBₐᵥₑ for the momentum during the no-operation time period. In the following description, the terminal momentum weight coefficients w_{d} and wₙₒₚ are referred to as weight coefficients w_{d} and wₙₒₚ.

If a parameter value is set to 0.05 (rad/s²), the weight coefficient w_{d} and the weight coefficient wₙₒₚ are set so that when the parameter value increases by 0.05 (rad/s²), the weight coefficients increase by 1 for the terminal momentum exceeding the threshold. If the parameter value is set to 0.01 (rad/s²), the weight coefficient w_{d} and the weight coefficient wₙₒₚ are set so that when the parameter value increases by 0.01 (rad/s²), the weight coefficients increase by 1 for the terminal momentum exceeding the threshold. Specifically, amounts of increase in the weight coefficients are set based on the parameter value.

The threshold PAₐᵥₑ for the kinetic power of the information processing terminal during the operation time period and the threshold PBₐᵥₑ for the kinetic power of the information processing terminal during the no-operation time period are determined based on a parameter value stored in the parameter storage section 228 and indicating a terminal momentum. For example, the parameter value may be assigned to the threshold PBₐᵥₑ, and the threshold PAₐᵥₑ may be set to a value obtained by adding a predetermined value to the threshold PBₐᵥₑ.

According to the weight coefficient w_{d} indicated in the aforementioned Equation (2) and illustrated in FIG. 10, if the kinetic power of the information processing terminal during the operation time period is equal to or smaller than the threshold PAₐᵥₑ, the weight coefficient w_{d} is equal to 1.0, and the operation time period is added to an evaluated value I(t) of the interest level. Thus, if the kinetic power of the information processing terminal during the operation time period is small and it is estimated that the level of user's interest in the content is high, the evaluated value I(t) of the interest level is high.

If the kinetic power of the information processing terminal during the operation time period exceeds the threshold PAₐᵥₑ, the weight coefficient w_{d} increases with an increase in the kinetic power, and an effect of the operation time period on the evaluated value I(t) of the interest level is small. Thus, if the kinetic power of the information processing terminal during the operation time period is large and it is estimated that the user does not concentrate on browsing the content, the evaluated value I(t) of the interest level is low.

According to the weight coefficient wₙₒₚ indicated in the aforementioned Equation (2) and illustrated in FIG. 10, if the kinetic power of the information processing terminal during the no-operation time period is equal to or smaller than the threshold PBₐᵥₑ, the weight coefficient wₙₒₚ is equal to 1.0 and the no-operation time period is added to the evaluated value I(t) of the interest level. Thus, if the kinetic power of the information processing terminal during the no-operation time period is small and it is estimated that the level of user's interest in the content is high, the evaluated value I(t) of the interest level is high.

If the kinetic power of the information processing terminal during the no-operation time period exceeds the threshold PBₐᵥₑ, the value of the weight coefficient wₙₒₚ increases with an increase in the kinetic power, and an effect of the no-operation time period on the evaluated value I(t) of the interest level is small. Thus, if the kinetic power of the information processing terminal during the no-operation time period is large and it is estimated that the user does not concentrate on browsing the content, the evaluated value I(t) of the interest level is low.

Similarly to the first embodiment, the interest level quantifying section 230 calculates, for each of the parameter values indicating the terminal momentums, the difference between an interest level calculated during a unit time period including a previous time point and an interest level calculated during a unit time period including the current time point, as the amount of change in the interest level during each of the time intervals arranged in chronological order.

The temporal change comparing and detecting section 232 compares the change amounts calculated for each of the parameter values during the time intervals arranged in chronological order with the change amounts calculated for the other parameter values during the time intervals arranged in chronological order. Then, the temporal change comparing and detecting section 232 detects the same time interval during which change amounts calculated for two or more parameter values are equal to or larger than the predetermined threshold. The temporal change comparing and detecting section 232 compares change amounts during a time interval preceding the detected same time interval during which the change amounts are equal to or larger than the predetermined threshold. Then, the temporal change comparing and detecting section 232 identifies a parameter value for which a change amount that is larger than a change amount calculated for the other parameter value during the preceding time interval has been calculated. Then, the temporal change comparing and detecting section 232 associates the detected same time interval (time interval over the threshold) during which the change amounts are equal to or larger than the predetermined threshold with a user ID, a content ID, and access time and causes the time interval over the threshold associated with the user ID, the content ID, and the access time to be stored in the user information storage section 233. The temporal change comparing and detecting section 232 associates the identified parameter value (identified parameter value) for which the change amount that is larger than the change amount calculated for the other parameter value has been calculated with the user ID, the content ID, and the access time, and the temporal change comparing and detecting section 232 causes the identified parameter value associated with the user ID, the content ID, and the access time to be stored in the user information storage section 233.

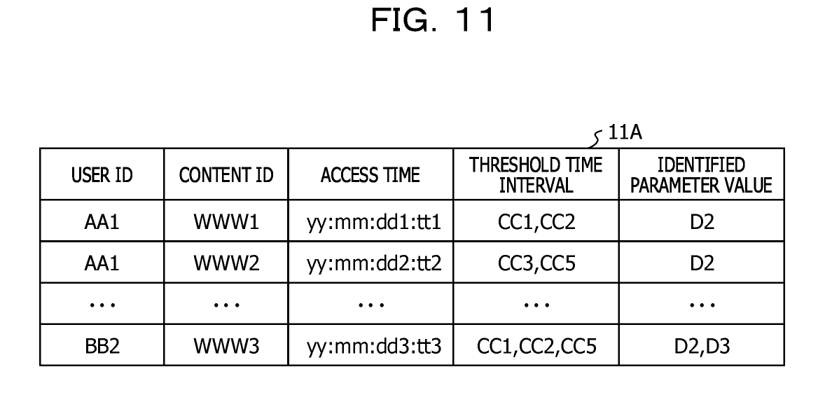

In the user information storage section 233, the time interval over the threshold and the identified parameter value are associated with the user ID, the content ID, and the access time and stored as user-specific information. For example, a table 11A illustrated in FIG. 11 indicates that a user having a user ID “AA2” browses a content having a content ID “WWW1” at time “yy:mm:dd1:tt1” and that time intervals over the threshold detected by the temporal change comparing and detecting section 32 upon the browsing are “CC1 and CC2” and a parameter value identified by the temporal change comparing and detecting section 32 upon the browsing is “D2”. In the user information storage section 233, the position, associated with time-series data, of the content on the display screen is stored.

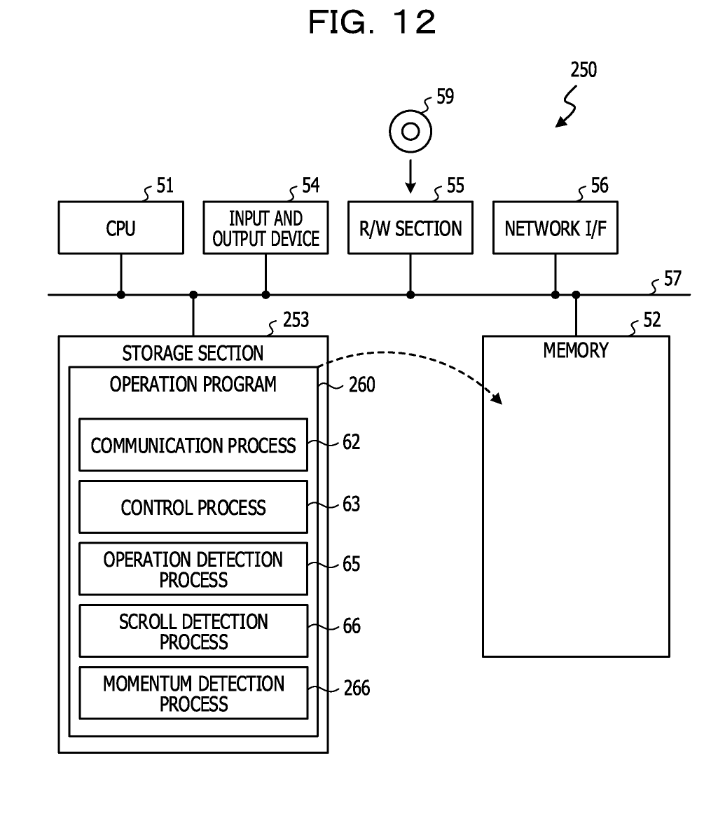

The information processing terminal 216 may be achieved by a computer 250 illustrated in FIG. 12, for example. The computer 250 includes a CPU 51, a memory 52 as a temporal storage region, and a nonvolatile storage section 253. The computer 250 further includes an input and output device 54, an R/W section 55, and a network I/F 56. The CPU 51, the memory 52, the storage section 253, the input and output device 54, the R/W section 55, and the network I/F 56 are connected to each other via a bus 57.

The storage section 253 may be achieved by an HDD, an SSD, a flash memory, or the like. In the storage section 253 serving as a storage medium, an operation program 260 that causes the computer 250 to function as the information processing terminal 216 is stored. The operation program 260 includes a communication process 62, a control process 63, an operation detection process 65, a scroll detection process 66, and a momentum detection process 266.

The CPU 51 reads the operation program 260 from the storage section 253, loads the read operation program 260 into the memory 52, and sequentially executes the processes included in the operation program 260. The CPU 51 executes the communication process 62, thereby operating as the communication section 18 illustrated in FIG. 9. The CPU 51 executes the control process 63, thereby operating as the controller 20 illustrated in FIG. 9. The CPU 51 executes the operation detection process 65, thereby operating as the operation detector 24 illustrated in FIG. 9. The CPU 51 executes the scroll detection process 66, thereby operating as the scroll detector 26 illustrated in FIG. 9. The CPU 51 executes the momentum detection process 266, thereby operating as the terminal momentum detector 227 illustrated in FIG. 9. Thus, the computer 250 executes the operation program 260, thereby functioning as the information processing terminal 216. The CPU 51 that executes the program is hardware.

The functions that are achieved by the operation program 260 may be achieved by a semiconductor integrated circuit, or more specifically, by an ASIC or the like, for example.

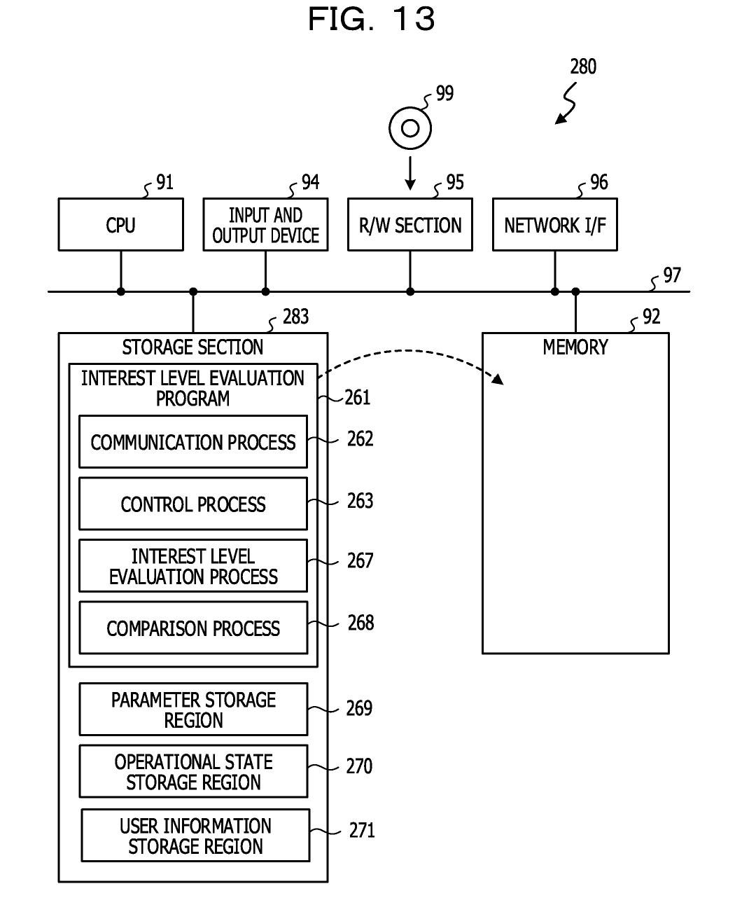

The user information managing server 213 may be achieved by a computer 280 illustrated in FIG. 13, for example. The computer 280 includes a CPU 91, a memory 92 as a temporal storage region, and a nonvolatile storage section 283. The computer 280 further includes an input and output device 94 including a display device, an input device, and the like, and an R/W section 95 that controls reading and writing of data from and to a recording medium 99. The computer 280 further includes a network I/F 96 that is connected to the network such as the Internet. The CPU 91, the memory 92, the storage section 283, the input and output device 94, the R/W section 95, and the network I/F 96 are connected to each other via a bus 97.

The storage section 283 may be achieved by an HDD, an SSD, a flash memory, or the like. In the storage section 283 serving as a storage medium, an interest level evaluation program 261 that causes the computer 280 to function as the user information managing server 213 is stored. The interest level evaluation program 261 includes a communication process 262, a control process 263, a calculation process 267, and a comparison process 268. The storage section 283 includes a parameter storage region 269 in which information constituting the parameter storage section 228 is stored. The storage section 283 includes an operational state storage region 270 in which information constituting the operational state storage section 219 is stored. The storage section 283 includes a user information storage region 271 in which information constituting the user information storage section 233 is stored.

The CPU 91 reads the interest level evaluation program 261 from the storage section 283, loads the read interest level evaluation program 261 into the memory 82, and sequentially executes the processes included in the interest level evaluation program 261. The CPU 91 executes the communication process 262, thereby operating as the communication section 218 illustrated in FIG. 9. The CPU 91 executes the control process 263, thereby operating as the server controller 220 illustrated in FIG. 9. The CPU 91 executes the calculation process 267, thereby operating as the interest level quantifying section 230 illustrated in FIG. 9. The CPU 91 executes the comparison process 268, thereby operating as the temporal change comparing and detecting section 232 illustrated in FIG. 9. The CPU 91 reads the information from the parameter storage region 269 and loads the parameter storage section 228 into the memory 92. The CPU 91 reads the information from the operational state storage region 270 and loads the operational state storage section 219 into the memory 92. The CPU 91 reads the information from the user information storage region 271 and loads the user information storage section 233 into the memory 92. Thus, the computer 280 executes the interest level evaluation program 261, thereby functioning as the user information managing server 213. The CPU 91 that executes the program is hardware.

The functions that are achieved by the interest level evaluation program 261 may be achieved by a semiconductor integrated circuit, or more specifically, by an ASIC or the like, for example.

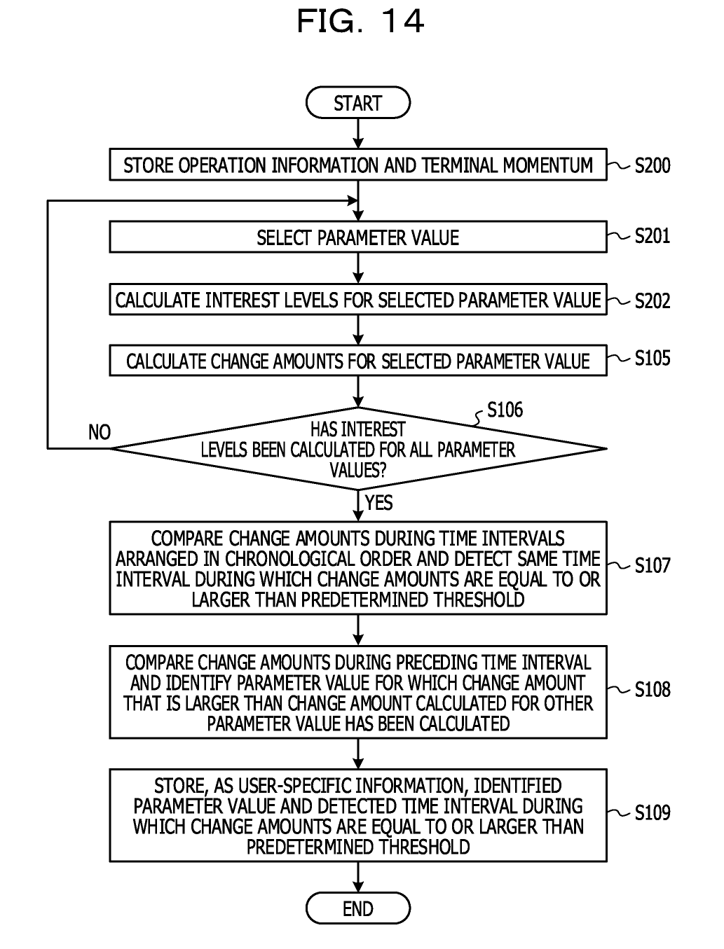

Next, effects of the interest level evaluation system 210 according to the second embodiment are described. In the interest level evaluation system 210, the information processing terminal 216 receives a content from the content server 12. Then, the content is displayed by the display section 22 of the information processing terminal 216. When an input operation is performed by a user, detection processes are executed by the operation detector 24, the scroll detector 26, and the terminal momentum detector 227 during each of the unit time periods. Then, the information processing terminal 216 executes the detection processes until the display of the content is terminated. Then, the communication section 18 of the information processing terminal 216 associates, based on a control process by the controller 20, operation information detected during each of the unit time periods and a terminal momentum detected during each of the unit time periods with a user ID, a content ID, and detection time and transmits the operation information and terminal momentum associated with the user ID, the content ID, and the detection time to the user information managing server 213 based on a control process by the controller 20. When the communication section 218 of the user information managing server 213 receives the information transmitted by the information processing terminal 216, the user information managing server 213 executes an interest level evaluation process illustrated in FIG. 14. Processes are described below.

In S200, the server controller 220 causes the operation information and terminal momentum detected during each of the unit time periods and received by the communication section 218 and associated with the user ID, the content ID, and the detection time to be stored in the operational state storage section 219. The server controller 220 notifies the interest level quantifying section 230 that the information has been stored in the operational state storage section 219.

In S201, the interest level quantifying section 230 selects a parameter value stored in the parameter storage section 228 and indicating a terminal momentum.

In S202, the interest level quantifying section 230 calculates, for the parameter value selected in S201, an interest level during each of the unit time periods. The interest level during each of the unit time periods is calculated according to the aforementioned Equation (2) based on an operation time period and no-operation time period indicated in the operation information stored in the operational state storage section 219 and the terminal momentum.

In S105 to S109, in the same manner as the first embodiment, change amounts are calculated, the same time interval during which change amounts are equal to or larger than the predetermined threshold is detected, and a parameter value for which a change amount that is larger than a change amount calculated for another parameter value has been calculated is identified. Then, the detected time interval and the identified parameter value are stored as user-specific information in the user information storage section 233.

As described above, upon receiving an input operation within a time period during which the information processing terminal displays a content, the interest level evaluation system according to the second embodiment detects operational states including the terminal momentum. Then, the user information managing server calculates interest levels for the parameter values based on the detected operational states and calculates amounts of change in the interest levels during the time intervals arranged in chronological order. Then, the server information managing server compares the change amounts and detects the same time interval during which change amounts calculated for two or more parameter values are equal to or larger than the predetermined threshold. Then, the user information managing server compares change amounts during a time interval preceding the detected same time interval and identifies a parameter value for which a change amount that is larger than a change amount calculated for the other parameter value during the preceding time interval has been calculated. Consequently, evaluation precision of the levels of users' interest in contents may be improved without depending on the contents.

### Third Embodiment

Next, a third embodiment is described. Sections that are the same as those described in the second embodiment are indicated by the same reference symbols as those described in the second embodiment, and a description thereof is omitted.

The third embodiment is different from the second embodiment in that a screen enlargement rate of an information processing terminal is used for interest level evaluation in the third embodiment.

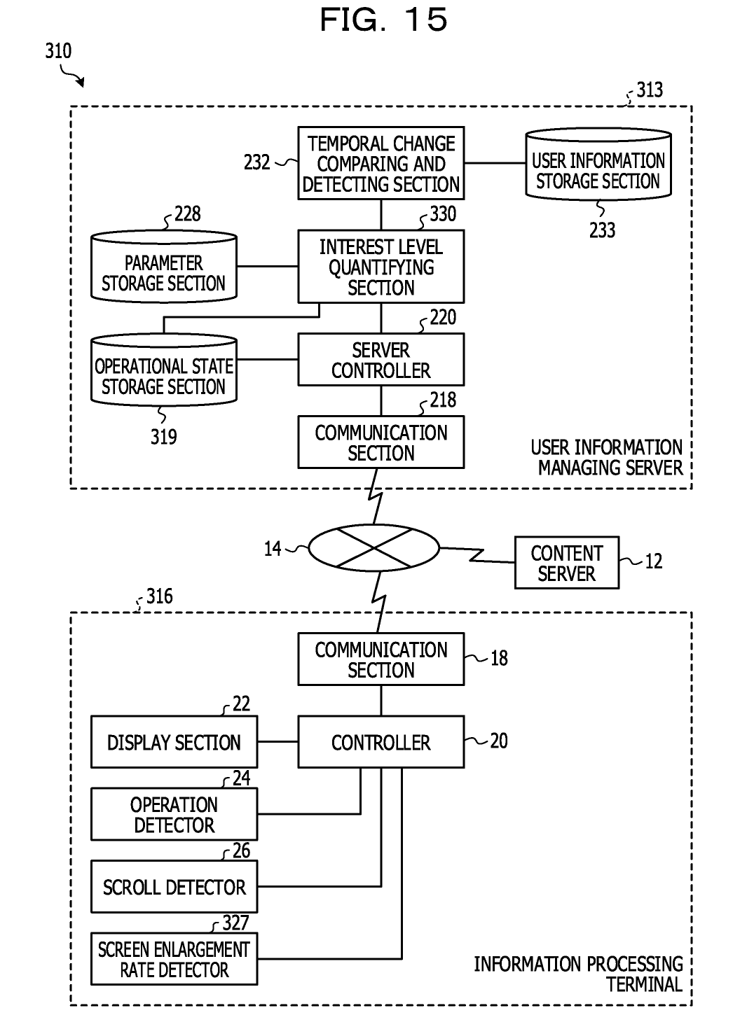

An interest level evaluation system 310 illustrated in FIG. 15 according to the third embodiment includes the content server 12, an information processing terminal 316, and a user information managing server 313. The content server 12, the information processing terminal 316, and the user information managing server 313 are connected to each other via the network 14 such as the Internet, for example.

The information processing terminal 316 includes the communication section 18, the controller 20, the display section 22, the operation detector 24, the scroll detector 26, and a screen enlargement rate detector 327.

The screen enlargement detector 327 detects a screen enlargement rate that is an example of an operational state of the information processing terminal 316. The screen enlargement rate is detected based on the state of an operation of zooming in and out a screen by pinch-out and pinch-in operations among input operations detected by the operation detector 24. The screen enlargement rate detector 327 detects a zoom operation time period for reduction and enlargement operations that are the pinch-in and pinch-out operations.

The communication section 18 according to the third embodiment transmits, to the user information managing server 213, operation information detected by the operation detector 24 and including the types of the input operations, time when the input operations have been performed, contact positions, and a no-operation time period, based on a control process by the controller 20. In the third embodiment, the operation information includes a scrolling velocity detected by the scroll detector 26. The communication section 18 transmits the screen enlargement rate detected by the screen enlargement rate detector 327 and the zoom operation time period detected by the screen enlargement rate detector 327 to the user information managing server 213. The operation information, the screen enlargement rate, and the zoom operation time period that are to be transmitted are associated with a user ID, a content ID of a content being displayed, and detection time for each of the unit time periods.

The user information managing server 313 includes the communication section 218, the server controller 220, an operational state storage section 319, the parameter storage section 228, an interest level quantifying section 330, the temporal change comparing and detecting section 232, and the user information storage section 233.

The communication section 218 according to the third embodiment receives the operation information, screen enlargement rate, and zoom operation time period associated with the user ID, the content ID, and the detection time and transmitted by the information processing terminal 316.

The server controller 220 according to the third embodiment acquires the operation information, screen enlargement rate, and zoom operation time period received by the communication section 218 and causes the operation information, the screen enlargement rate, and the zoom operation time period to be stored in the operational state storage section 319. The server controller 220 notifies the interest level quantifying section 330 that the newly received operation information, the newly received screen enlargement rate, and the newly received zoom operation time period have been stored in the operational state storage section 319.

In the operational state storage section 319, the operation information, the screen enlargement rate, and the zoom operation time period are associated with the user ID, the content ID, and the detection time and stored.

The interest level quantifying section 330 calculates interest levels during each of the unit time periods based on a scroll operation time period, no-operation time period, and scrolling velocity included in the operation information stored in the operational state storage section 319, the screen enlargement rate, and the zoom operation time period. The interest level quantifying section 330 calculates the interest levels for each of the parameter values stored in the parameter storage section 228 and indicating scrolling velocities.

For example, the interest level quantifying section 330 determines a weight coefficient for the scrolling velocity based on the threshold determined based on the parameter values stored in the parameter storage section 228 and indicating the scrolling velocities. A method for determining the weight coefficient for the scrolling velocity is the same as or similar to that described in the first embodiment. Weight coefficients for the screen enlargement rate are determined based on the screen enlargement rate. Then, the interest level quantifying section 330 calculates a level I(t) of user's interest in the content according to the following Equation (3) based on a scroll operation time period, a no-operation time period, the weight coefficient for the scrolling velocity, and the weight coefficients for a screen enlargement rate. The weight coefficients for the screen enlargement rate are an example of a change in the screen enlargement rate.

$$Equation ( 3 )$$

$$I ( t ) = \sum A time period for a zoom operation + \sum \frac{A time period for a scroll operation}{The scrolling velocity weight coefficient {w}_{scr}} * The enlargement rate coefficient {z}_{scr} + \sum A no \text{-} operation time period * The enlargement rate coefficient {z}_{nop}$$

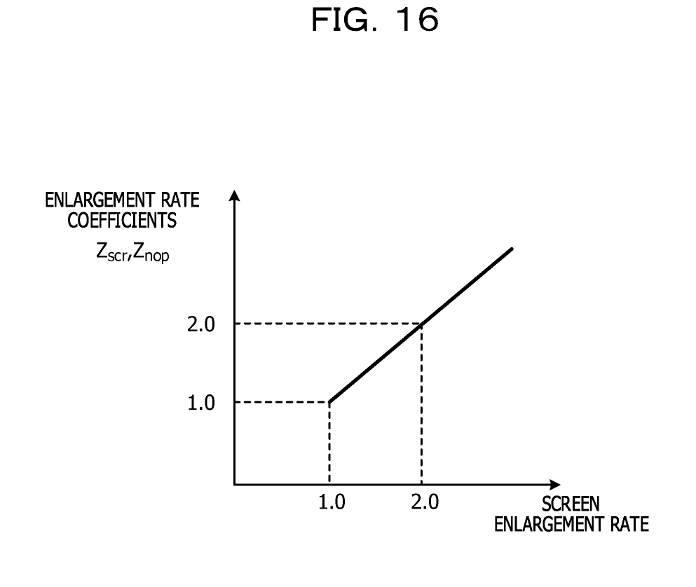

In the third embodiment, the level I(t) of interest in the content is calculated for each of the unit time periods (of 1 second as an example). In the aforementioned Equation (3), a method for setting the weight w_{scr} for the scrolling velocity is the same as or similar to that described in the first embodiment. The weight coefficients for the screen enlargement rate are set for an enlargement rate coefficient z_{scr} and an enlargement rate coefficient zₙₒₚ. The enlargement rate coefficient zₛᵣ is a weight coefficient related to the screen enlargement rate and provided for an operation time period. The enlargement rate coefficient zₙₒₚ is a weight coefficient related to the screen enlargement rate and provided for a no-operation time period. For example, as illustrated in FIG. 16, it is assumed that a weight when the screen enlargement rate is 2.0 is 1.0 and that as the enlargement rate is higher, the level of user's interest in the content is higher. Based on this assumption, the enlargement rate coefficients z_{scr} and zₙₒₚ are set so that the enlargement rate coefficients z_{scr} and zₙₒₚ linearly increase with an increase in the screen enlargement rate. In an example illustrated in FIG. 16, when the screen enlargement rate is increased to 2.0, the enlargement rate coefficients z_{scr} and zₙₒₚ increase to 2.0. Specifically, the enlargement rate coefficients z_{scr} and zₙₒₚ increase by 1 based on a multiple of the screen enlargement rate. In the third embodiment, the rates of increase in the enlargement rate coefficients z_{scr} and zₙₒₚ are equal to each other. For example, based on the assumption that an interest level is high during a no-operation time period, the rate of increase in the enlargement rate coefficient zₙₒₚ may be 1.2.

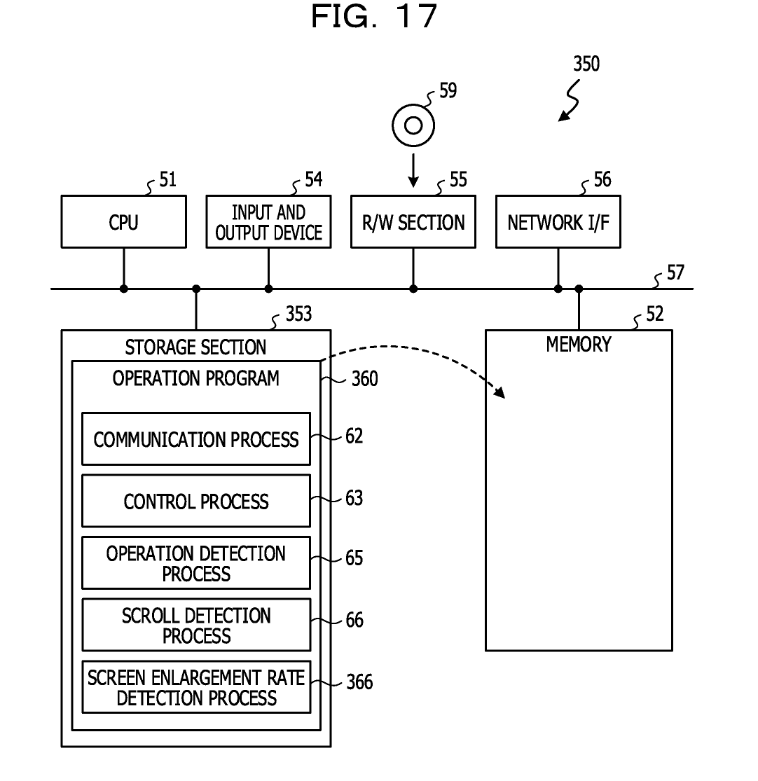

The information processing terminal 316 may be achieved by a computer 350 illustrated in FIG. 17, for example. The computer 350 includes the CPU 51, the memory 52 as a temporal storage region, and a nonvolatile storage section 353. The computer 350 further includes the input and output device 54, the R/W section 55, and the network I/F 56. The CPU 51, the memory 52, the storage section 253, the input and output device 54, the R/W section 55, and the network I/F 56 are connected to each other via the bus 57.

The storage section 353 may be achieved by an HDD, an SSD, a flash memory, or the like. In the storage section 353 serving as a storage medium, an operation program 360 that causes the computer 350 to function as the information processing terminal 316 is stored. The operation program 360 includes the communication process 62, the control process 63, the operation detection process 65, the scroll detection process 66, and a screen enlargement rate detection process 366.

The CPU 51 reads the operation program 360 from the storage section 353, loads the read operation program 360 into the memory 52, and sequentially executes the processes included in the operation program 360. The CPU 51 executes the communication process 62, thereby operating as the communication section 18 illustrated in FIG. 15. The CPU 51 executes the control process 63, thereby operating as the controller 20 illustrated in FIG. 15. The CPU 51 executes the operation detection process 65, thereby operating as the operation detector 24 illustrated in FIG. 15. The CPU 51 executes the scroll detection process 66, thereby operating as the scroll detector 26 illustrated in FIG. 15. The CPU 51 executes the screen enlargement rate detection process 366, thereby operating as the screen enlargement rate detector 327 illustrated in FIG. 15. Thus, the computer 350 executes the operation program 360, thereby functioning as the information processing terminal 316. The CPU 51 that executes the program is hardware.

The functions that are achieved by the operation program 360 may be achieved by a semiconductor integrated circuit, or more specifically, by an ASIC or the like, for example.

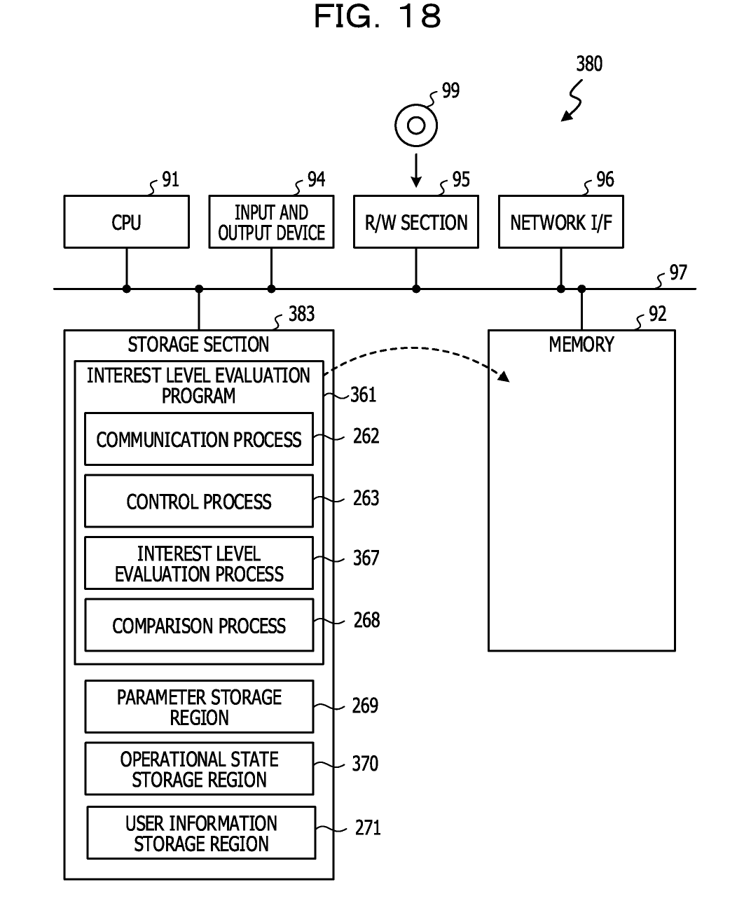

The user information managing server 313 may be achieved by a computer 380 illustrated in FIG. 18, for example. The computer 380 includes the CPU 91, the memory 92 as a temporal storage region, and a nonvolatile storage section 383. The computer 380 further includes the input and output device 94 and the R/W section 95 that controls reading and writing of data from and to the recording medium 99. The computer 380 further includes the network I/F 96 that is connected to the network such as the Internet. The CPU 91, the memory 92, the storage section 383, the input and output device 94, the R/W 95, and the network I/F 96 are connected to each other via the bus 97.

The storage section 383 may be achieved by an HDD, an SSD, a flash memory, or the like. In the storage section 383 serving as a storage medium, an interest level evaluation program 361 that causes the computer 380 to function as the user information managing server 313 is stored. The interest level evaluation program 361 includes the communication process 262, the control process 263, a calculation process 367, and the comparison process 268. The storage section 383 includes the parameter storage region 269 in which the information constituting the parameter storage section 228 is stored. The storage section 383 includes an operational state storage region 370 in which information constituting the operational state storage section 319 is stored. The storage section 383 includes the user information storage region 271 in which the information constituting the user information storage section 233 is stored.

The CPU 91 reads the interest level evaluation program 361 from the storage section 383, loads the read interest level evaluation program 361 into the memory 92, and sequentially executes the processes included in the interest level evaluation program 361. The CPU 91 executes the communication process 262, thereby operating as the communication section 218 illustrated in FIG. 15. The CPU 91 executes the control process 263, thereby operating as the server controller 220 illustrated in FIG. 15. The CPU 91 executes the calculation process 367, thereby operating as the interest level quantifying section 330 illustrated in FIG. 15. The CPU 91 executes the comparison process 268, thereby operating as the temporal change comparing and detecting section 232 illustrated in FIG. 15. The CPU 91 reads the information from the parameter storage region 269 and loads the parameter storage section 228 into the memory 92. The CPU 91 reads the information from the operational state storage region 370 and loads the operational state storage section 319 into the memory 92. The CPU 91 reads the information from the user information storage region 271 and loads the user information storage section 233 into the memory 92. Thus, the computer 380 executes the interest level evaluation program 361, thereby functioning as the user information managing server 313. The CPU 91 that executes the program is hardware.

The functions that are achieved by the interest level evaluation program 361 may be achieved by a semiconductor integrated circuit, or more specifically, by an ASIC or the like, for example.

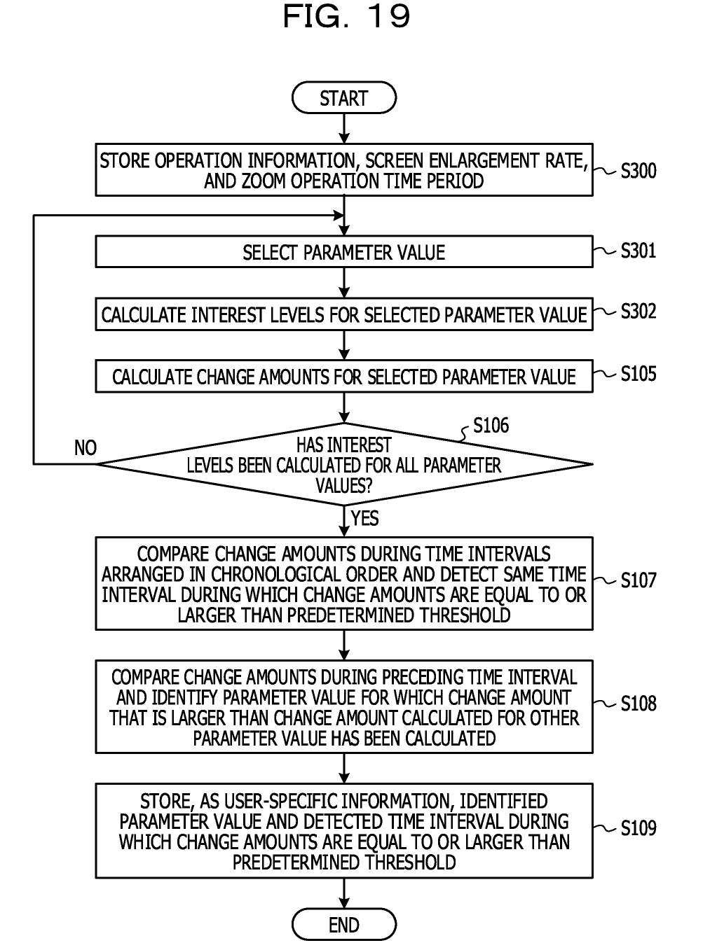

Next, effects of the interest level evaluation system 310 according to the third embodiment are described. In the interest level evaluation system 310, the information processing terminal 316 receives a content from the content server 12. Then, the content is displayed by the display section 22 of the information processing terminal 316. When an input operation is performed by a user, detection processes are executed by the operation detector 24, the scroll detector 26, and the screen enlargement rate detector 327 for each of the unit time periods. Then, the information processing terminal 316 executes the detection processes until the display of the content is terminated. Then, the communication section 18 of the information processing terminal 316 associates, based on a control process by the controller 20, operation information, screen enlargement rate, and zoom operation time period detected for each of the unit time periods with a user ID, a content ID, and detection time and transmits the operation information, screen enlargement rate, and zoom operation time associated with the user ID, the content ID, and the detection time to the user information managing server 313. When the communication section 218 of the user information managing server 313 receives the information transmitted by the information processing terminal 316, the user information managing server 313 executes an interest level evaluation process illustrated in FIG. 19. Processes are described below.

In S300, the server controller 220 causes the operation information and screen enlargement rate detected for each of the unit time periods and received by the communication unit 218 and associated with the user ID, the content ID, and the detection time to be stored in the operational state storage section 319. The server controller 220 notifies the interest level quantifying section 330 that the information has been stored in the operational state storage section 319.

In S301, the interest level quantifying section 330 selects a parameter value stored in the parameter storage section 228 and indicating a scrolling velocity.

In S302, the interest level quantifying section 330 calculates, for the selected parameter value, an interest level during each of the unit time periods. The interest level during each of the unit time periods is calculated according to the aforementioned Equation (3) based on a scroll operation time period, no-operation time period, and scrolling velocity included in the operation information stored in the operational state storage section 319, the screen enlargement rate, and the zoom operation time period.

In S105 to S109, in the same manner as the first embodiment, change amounts are calculated, the same time interval during which change amounts are equal to or larger than the predetermined threshold is detected, and a parameter value for which a change amount that is larger than a change amount calculated for another parameter value has been calculated is identified. Then, the detected time interval and the identified parameter value are stored as user-specific information in the user information storage section 233.

As described above, upon receiving an input operation within a time period during which the information processing terminal displays a content, the interest level evaluation system according to the third embodiment detects operational states including a scrolling velocity and a screen enlargement rate. Then, the user information managing server calculates interest levels for the parameter values based on the detected operational states and calculates amounts of change in the interest levels during the time intervals arranged in chronological order. Then, the user information managing server compares the change amounts and detects the same time interval during which change amounts calculated for two or more parameter values are equal to or larger than the predetermined threshold. Then, the user information managing server compares change amounts during a time interval preceding the detected same time interval and identifies a parameter value for which a change amount that is larger than a change amount calculated for the other parameter value during the preceding time interval has been calculated. Consequently, evaluation precision of the levels of users' interest in contents may be improved without depending on the contents.

Next, a modified example of the embodiments is described.

Although the first embodiment among the aforementioned embodiments exemplifies the case where the information processing terminal uses an operation time period and a scrolling velocity to calculate interest levels and amounts of change in the interest levels, the first embodiment is not limited to this. For example, the information processing terminal may use an operation time period, a no-operation time period, and a terminal momentum to calculate the interest levels. The information processing terminal may use an operation time period, a no-operation time period, a scrolling velocity, a screen enlargement rate, and a zoom operation time period to calculate the interest levels. In addition, the information processing terminal may execute a process of modifying a content based on the result of the process of evaluating levels of user's interest and execute a process of transmitting the results of the execution to the content server. By executing this, the efficiency of the process of modifying a content may be improved. In addition, in the second and third embodiments, the aforementioned modification process may be executed by the user information managing server.

The second and third embodiments exemplify the case where each of the interest level evaluation systems is composed of an information processing terminal, the content server, and a user information managing server, but are not limited to this. For example, a proxy server may be installed in each of the interest level evaluation systems. Each of the information processing terminals acquires a content from the content server via the proxy server. If the proxy server is installed, the proxy server includes an analysis tag inserting section, an operational state storage section, an interest level quantifying section, and a temporal change comparing and detecting section, and each of the user information managing servers includes a user information storage section. In the case where each of the information processing terminals acquires a content from the content server, the analysis tag inserting section of the proxy server inserts a specific analysis tag in the content and enables the content to be analyzed. Based on the analysis tag inserted in the content, operational states of the users' information processing terminals are operation information, a terminal momentum, a screen enlargement rate, and the like and are acquired. The interest level quantifying section calculates interest levels for the parameter values based on the acquired operational states and calculates amounts of change in the interest levels. The change amounts for each of the parameter values are compared with the change amounts for the other parameter values, and the results of the comparison are stored in the user information storage section of the user information managing server.

In each of the interest level evaluation systems according to the second and third embodiments, the analysis tag inserting section may be installed in each of the user information managing servers. In the case where each of the information processing terminals acquires a content from the content server, it is sufficient if each of the user information managing servers acquires the content via the analysis tag inserting section.

Methods for calculating interest levels are not limited to the methods using the equations exemplified in the embodiments. For example, interest levels may be calculated according to the following Equation (4) obtained by combining the equations that are described in the embodiments and used to calculate interest levels.

$$Equation ( 4 )$$

$$I ( t ) = \sum \frac{A time period for a zoom operation}{The terminal momentum weight coefficient {w}_{d}} + \sum \frac{A operation time period}{\begin{matrix}The scrolling velocity weight coefficient {w}_{scr} * \\ The terminal momentum weight coefficient {w}_{d}\end{matrix}} * The enlargement rate coefficient {z}_{scr} + \sum \frac{A no \text{-} operation time period}{The terminal momentum weight coefficient {w}_{nop}} * The enlargement rate coefficient {z}_{nop}$$

In the case where interest levels are calculated using the aforementioned Equation (4), it is sufficient if the interest levels are calculated for each of combinations of parameter values indicating scrolling velocities and parameter values indicating terminal momentums.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An interest level evaluation method executed by a processor of a computer, the interest level evaluation method comprising:
detecting an operational state within a time period during which an information processing terminal displays a content;
calculating, for each of a plurality of parameter values related to the operational state, a level of interest in the content for each of a plurality of unit time periods based on the detected operational state and the plurality of parameter values;
calculating, for each of the plurality of parameter values, amounts of change in the level of interest during a plurality of time intervals arranged in chronological order based on the level of interest calculated for each of the plurality of unit time periods; and
evaluating the level of interest in the content by comparing the calculated amounts of change in the interest levels for each of the plurality of parameter values with the calculated amounts of change in the level of interest for another parameter value.

2. The interest level evaluation method according to claim 1,
wherein the detecting includes
detecting a scroll operation as an operational state within a time period during which the information processing terminal displays the content,
wherein the interest level evaluation method further comprises
calculating a velocity of the scroll operation during an operation time period from a detection of the start of the scroll operation to a detection of termination of the scroll operation, and
wherein the plurality of parameter values include a plurality of values related to the velocity of the scroll operation.

3. The interest level evaluation method according to claim 2, wherein the detecting further includes
detecting, as an operational state, a screen enlargement rate of the information processing terminal.

4. The interest level evaluation method according to claim 1,
wherein the detecting includes detecting, as operational states, a time period for an operation of the information processing terminal and a momentum of the information processing terminal within the time period during which the information processing terminal displays the content, and
wherein the plurality of parameter values include a plurality of values related to the momentum of the information processing terminal.

5. The interest level evaluation method according to claim 1, wherein the comparing includes
detecting a time interval during which change amounts calculated for the plurality of parameter values are equal to or larger than a predetermined threshold.

6. The interest level evaluation method according to claim 5, wherein the comparing further includes:
comparing change amounts calculated for the plurality of parameter values during a time interval close to the time interval during which the change amounts are equal to or larger than the predetermined threshold, and
identifying a parameter value that is among the plurality of parameter values and for which a change amount that is larger than a change amount calculated for another parameter value has been calculated.

7. An interest level evaluating device comprising:
a memory; and
a processor coupled to the memory and configured to:
receive an input of a first scroll operation within a time period during which an information processing terminal displays a content,
calculating the velocity of the first scroll operation during a first operation time period from the reception of the input of the first scroll operation to the detection of the termination of the first scroll operation,
calculating the velocity of a second scroll operation during a second operation time period for the second scroll operation input and received after the first scroll operation, and
evaluating a level of interest in the content based on a change from the calculated velocity of the first scroll operation to the calculated velocity of the second scroll operation.

8. A computer-readable recording medium having stored therein a program for evaluating interest level of a content, the program execute a process comprising:
receiving an input of a first scroll operation within a time period during which an information processing terminal displays the content;
calculating a velocity of the first scroll operation during a first operation time period from a reception of the input first scroll operation to a detection of termination of the first scroll operation;
calculating a velocity of a second scroll operation during a second operation time period for the second scroll operation input and received after the first scroll operation; and
evaluating a level of interest in the content based on a change from the calculated velocity of the first scroll operation to the calculated velocity of the second scroll operation.

9. An interest level evaluation method executed by a processor of a computer, the interest level evaluation method comprising:
receiving an input of a first scroll operation within a time period during which an information processing terminal displays a content;
calculating a velocity of the first scroll operation during a first operation time period from a reception of the input first scroll operation to a detection of termination of the first scroll operation;
calculating a velocity of a second scroll operation during a second operation time period for the second scroll operation input and received after the first scroll operation; and
evaluating a level of interest in the content based on a change from the calculated velocity of the first scroll operation to the calculated velocity of the second scroll operation.

10. An interest level evaluation method executed by a processor of a computer, the interest level evaluation method comprising:
when an input of an operation within a time period during which an information processing terminal displays a content,
detecting an operation time from a reception of the input of the operation to a detection of termination of the operation, and
detecting a momentum of the information processing terminal within the time period during which the information processing terminal displays the content; and
evaluating a level of interest in the content based on the detected operation time and change of the motion.

11. The interest level evaluation method according to claim 10, further comprising
detecting a screen enlargement rate of the information processing terminal within the time period during which the information processing terminal displays the content,
wherein the evaluating includes
evaluating the level of interest in the content based on a change in the detected screen enlargement rate and the change from the calculated velocity of the first scroll operation to the calculated velocity of the second scroll operation.
